(19) United States
(12) Patent Application Publication
(10) Pub. No.: US 2026/0195594 A1
(43) Pub. Date: Jul. 9, 2026

(54) USE OF NOISY FORWARD MODULES FOR NEURAL NETWORK HIDDEN LAYER MODEL INFERENCE AND TRAINING

(71) Applicant: INTERNATIONAL BUSINESS MACHINES CORPORATION, ARMONK, NY (US)

(72) Inventors: Guy Amit, Tel Aviv (IL); Abigail Goldsteen, Haifa (IL); ARIEL FARKASH, Shimshit (IL)

(21) Appl. No.: 19/011,684

(22) Filed: Jan. 7, 2025

(51) Int. Cl. G06N 3/084

(52) U.S. Cl. CPC G06N 3/084

(57) ABSTRACT

A method and computer program product for: performing inference using a trained neural network hidden layer model that includes hidden layers, an input layer, and an output layer; and training the neural network hidden layer model. The input layer receives a query that includes a sequence of tokens, converts the sequence of tokens to embeddings, and passes the embeddings to a first hidden layer. Each hidden layer generates an activation matrix A. A Noisy Forward module between successive hidden layers: (i) clips the matrix A to generate a clipped matrix A_{c}; (ii) generates noise ξ via random sampling from a full or half unimodal symmetric distribution; (iii) computes a modified activation matrix A′ via A′=A_{c}+ξ; and (iv) passes A′ to the next hidden layer. The last hidden layer passes A′ to the output layer. The output layer generates and outputs an answer to the query.

### BACKGROUND

The present invention relates to performing inference using a trained neural network model and for training the neural network model, and more specifically to modifying activation matrices generated by hidden layers of a neural network hidden layer model to enhance privacy while preserving accuracy.

### SUMMARY

Embodiments of the present invention provide a method and a computer program product for performing inference using a trained neural network hidden layer model. An input layer of a trained large language model (LLM) receives a query that includes a sequence of tokens, each token being a unit of text, wherein the trained neural network hidden layer model includes N hidden layers and an output layer, and wherein N≥1. The sequence of tokens is converted, by the input layer, to embeddings. The embeddings are passed from the input layer to a first hidden layer H₁. An activation matrix A is generated by each hidden layer. A Noisy Forward (NF) module between successive hidden layers performs: (i) clipping the matrix A to generate a clipped matrix A_{c}; (ii) generating noise ξ derived from a number randomly sampled from a probability density function (PDF) consisting of a unimodal symmetric distribution or a half unimodal symmetric distribution; (iii) computing a modified activation matrix A′ via A′=A_{c}+ξ; and (iv) passing A′ to the next hidden layer if the next hidden layer exists. A′ is passed from the last hidden layer to the output layer. The output layer generates and outputs an answer to the query.

Embodiments of the present invention provide a method and a computer program product for training a neural network hidden layer model. An input layer of a neural network hidden layer model receives input of Q queries and Q respectively associated answers to the Q queries denoted as query 1, . . . , query Q wherein Q>1, each query including a sequence of tokens, each token being a unit of text, said neural network hidden layer model comprising the input layer, N hidden layers denoted as H₁, . . . , H_{N}, and an output layer, wherein N≥1. The input layer converts each token to an embedding for each query, wherein the embeddings are collectively denoted as E_{q} for query q (q=1, . . . , Q). The hidden layer H₁ receives, from the input layer, training data comprising E_{q} and R_{q}, wherein R_{q} is the answer to query q (q=1, . . . , Q). The neural network hidden layer model is trained, using the training data, by minimizing a loss function using backpropagation, said training comprising for each q (q=1, . . . , Q). The training comprises for each q (q=1, . . . , Q): for n=1, . . . , N the following steps. An activation matrix A is generated by each hidden layer. A Noisy Forward (NF) module between successive hidden layers performs: (i) clipping the matrix A to generate a clipped matrix A_{c}; (ii) generating noise ξ derived from a number randomly sampled from a probability density function (PDF) consisting of a unimodal symmetric distribution or a half unimodal symmetric distribution; (iii) computing a modified activation matrix A′ via A′=A_{c}+ξ; and (iv) passing A′ to the next hidden layer if the next hidden layer exists. A′ is passed from the last hidden layer to the output layer. The output layer generates an answer to the query q. The loss function is minimized, using backpropagation, with respect to a comparison between the generated answer to the query q in the output layer and the inputted answer R_{q} to query q.

### BRIEF DESCRIPTION OF THE DRAWINGS

FIG. 1 depicts a large language model (LLM), comprising an input layer, hidden layers, and an output layer, in accordance with embodiments of the present invention.

FIG. 2 depicts the LLM of FIG. 1 showing the hidden layers of the LLM in greater detail, in accordance with embodiments of the present invention.

FIG. 3 depicts a modification of using the LLM in FIG. 2 for training the LLM, in accordance with embodiments of the present invention.

FIG. 4A is a flow chart of a method for performing inference using a trained large language model (LLM), in accordance with embodiments of the present invention.

FIGS. 4B and 4C are flow charts collectively providing an alternative description of the method of FIG. 4A, in accordance with embodiments of the present invention.

FIG. 5 is a flow chart of a method for training a large language model (LLM), in accordance with embodiments of the present invention.

FIG. 6A is a flow chart of a process that performs a training step of FIG. 5 in more detail, in accordance with embodiments of the present invention.

FIG. 6B is a flow chart describing the processing of hidden layers in a step of FIG. 6A in more detail, in accordance with embodiments of the present invention.

FIG. 7 is a flow chart of a process that that describes, in more detail, the process described in FIG. 6B that processes the hidden layers for a query, in accordance with embodiments of the present invention.

FIG. 8 illustrates a computer system, in accordance with embodiments of the present invention.

FIG. 9 depicts a computing environment which contains an example of an environment for the execution of at least some of the computer code involved in performing the inventive methods, in accordance with embodiments of the present invention.

### DETAILED DESCRIPTION

According to an aspect of the invention, an input layer of a trained neural network hidden layer model receives a query that includes a sequence of tokens, each token being a unit of text, said neural network hidden layer model comprising the input layer, N hidden layers denoted as H₁, . . . , H_{N}, and an output layer, wherein N≥1. The input layer converts each token to an embedding, wherein the embeddings are collectively denoted as E. Hidden layer H₁ receives E from the input layer. For n=1, . . . , N: (i) Hidden layer Hₙ generates an activation matrix Aₙ; (ii) a Noisy Forward (NF) module NFₙ generates, using Aₙ, a clipped matrix A_{C,n} and noise ξₙ equal to a number randomly sampled from a probability density function (PDF) consisting of a unimodal symmetric distribution or a half unimodal symmetric distribution or is an absolute value of a number randomly sampled from a PDF consisting of the unimodal symmetric distribution, wherein ξₙ is either a scalar resulting from ξₙ being sampled only once from the PDF or a matrix resulting from ξₙ being sampled from the PDF once for each element of Aₙ, and wherein the NFₙ module is disposed between hidden layer Hₙ and a next hidden layer Hₙₑₓₜ consisting of either Hₙ₊₁ if n<N or the output layer if n=N; (iii) the NFₙ module computes a modified activation matrix Aₙ′ via Aₙ′=A_{C,n}+ξₙ; and (iv) The NFₙ module passes Aₙ′ to Hₙₑₓₜ. The output layer generates and outputs an answer to the query. Generating A_{C,n} comprises computing A_{C,n} via A_{C,n}=γₙAₙ, wherein γₙ is a parameter that has a scalar value, and wherein the PDF includes a dependence on (1−γₙ) that controls a spread of the PDF.

The preceding aspect of the invention provides a technical feature of replacing a portion of the activation matrix at each hidden layer with randomly generated noise, in a manner that protects the privacy of the data in the activation matrix while preserving the accuracy of the activation matrix during performance of inference using the neural network hidden layer model.

According to a first embodiment, N≥2 and γₙ is a constant whose value γ is independent of n (n=1, . . . , N), and according to a second embodiment, N≥2 and γₙ varies with respect to n (n=1, . . . , N); for example in a special case fulfilling the condition: γ₁< . . . <γ_{N}.

The preceding first and second embodiments advantageously provide flexible use and tailoring of the parameter γₙ. For example, the constant value γ may be suitable if γ is at least a threshold value γₜₕ (e.g., 0.95, 0.975) such that there is negligible attenuation of the modified activation matrix in successive hidden layers. However, if γ is less than γₜₕ, then the attenuation of the activation matrix in successive hidden layers may result in unacceptable loss in accuracy in the modified activation matrix and implementation of a varying γₙ with respect to n (n=1, . . . , N), for example such that γ₁< . . . <γ_{N} may enable acceptable accuracy in the modified activation matrix in successive hidden layers.

According to one embodiment, γₙ is in a range of 0.95≤γₙ≤1 for n=1, . . . , N.

The preceding one embodiment advantageously specifies values of γₙ sufficiently close to 1 so that the small attenuation (5% or less) of the modified activation matrix in successive hidden layers results in acceptable accuracy of the modified activation matrix in successive hidden layers.

According to one embodiment, 0<γₙ<1 for each hidden layer n of the N hidden layers.

The preceding one embodiment advantageously allows for random noise to be added to the activation matrix generated in all of the hidden layers to ensure privacy of the data in the modified activation matrix in each hidden layer.

According to one embodiment, γₘ=1 for at least one hidden layer m of the N hidden layers.

The preceding one embodiment advantageously avoids modifying the activation matrix generated by at the least one hidden layer m so as to avoid accuracy loss and unnecessary computation time in cases in which modifying the activation matrix in the at least one hidden layer m is not needed for protecting privacy of the data.

According to a first embodiment ξₙ is the scalar resulting from the PDF being sampled only once, and according to a second embodiment ξₙ is the matrix resulting from the PDF being sampled for each element of Aₙ.

The preceding first and second embodiments advantageously provide a flexible tradeoff between privacy of data and efficiency. The first embodiment performs only one random sampling, which increases efficiency and decreases privacy of data by adding noise that is less random than if ξₙ is the matrix of the second embodiment. The second embodiment performs multiple random samplings, namely one random sampling for each element of Aₙ, which decreases efficiency and increases privacy of data.

According to one embodiment, the PDF is a normal probability distribution, a half normal probability distribution, a Laplace probability distribution, or a half Laplace probability distribution.

The preceding one embodiment advantageously provides flexibility in the choice of a probability distribution for determining the noise ξₙ via random sampling.

According to an aspect of the invention, an input layer of a neural network hidden layer model receives input of Q queries and Q respectively associated answers to the Q queries denoted as query 1, . . . , query Q wherein Q>1, each query including a sequence of tokens, each token being a unit of text, said neural network hidden layer model comprising the input layer, N hidden layers denoted as H₁, . . . , H_{N}, and an output layer, wherein N≥1. The input layer converts each token to an embedding for each query, wherein the embeddings are collectively denoted as E_{q} for query q (q=1, . . . , Q). The hidden layer H₁ receives, from the input layer, training data comprising E_{q} and R_{q}, wherein R_{q} is the answer to query q (q=1, . . . , Q). The neural network hidden layer model is trained, using the training data, by minimizing a loss function using backpropagation. The training comprises for each q (q=1, . . . , Q): for n=1, . . . , N: (i) Hidden layer Hₙ generates an activation matrix Aₙ; (ii) a Noisy Forward (NF) module NFₙ generates, using Aₙ, a clipped matrix A_{C,n} and noise ξₙ equal to a number randomly sampled from a probability density function (PDF) consisting of a unimodal symmetric distribution or a half unimodal symmetric distribution or equal to an absolute value of a number randomly sampled from a PDF consisting of the unimodal symmetric distribution, wherein ξₙ is either a scalar resulting from ξₙ being sampled only once from the PDF or a matrix resulting from ξₙ being sampled from the PDF once for each element of Aₙ, and wherein the NFₙ module is disposed between hidden layer Hₙ and a next hidden layer Hₙₑₓₜ consisting of either Hₙ₊₁ if n<N or the output layer if n=N; (iii) the NFₙ module computes a modified activation matrix Aₙ′ via Aₙ′=A_{C,n}+ξₙ; and (iv) The NFₙ module passes Aₙ′ to Hₙₑₓₜ. The output layer generates an answer to the query q. The loss function is minimized, using backpropagation, with respect to a comparison between the generated answer to the query q in the output layer and the inputted answer R_{q} to query q. Generating A_{C,n} comprises computing A_{C,n} via A_{C,n}=γₙAₙ, wherein γₙ is a parameter that has a scalar value, and wherein the PDF includes a dependence on (1−γₙ) that controls a spread of the PDF.

The preceding aspect of the invention provides a technical feature of replacing a portion of the activation matrix at each hidden layer with randomly generated noise, in a manner that protects the privacy of the data in the activation matrix while preserving the accuracy of the activation matrix during the training of the neural network hidden layer model.

According to a first embodiment, N≥2 and γₙ is a constant whose value γ is independent of n (n=1, . . . , N), and according to a second embodiment, N≥2 and γₙ varies with respect to n (n=1, . . . , N) and in a special case, γ₁< . . . <γ_{N}.

The preceding first and second embodiments advantageously provide flexible use and tailoring of the parameter γₙ. For example, the constant value γ may be suitable if γ is at least a threshold value γₜₕ (e.g., 0.95, 0.975) such that there is negligible attenuation if the modified activation matrix in successive hidden layers. However, if γ is less than γₜₕ, then the attenuation of the activation matrix in successive hidden layers may result in unacceptable loss in accuracy in the modified activation matrix and implementation of γ₁< . . . <γ_{N} may enable acceptable accuracy in the modified activation matrix in successive hidden layers.

According to one embodiment, γₙ is in a range of 0.95≤γₙ≤1 for n=1, . . . , N.

The preceding one embodiment advantageously specifies values of γₙ sufficiently close to 1 so that the small attenuation (5% or less) of the modified activation matrix in successive hidden layers results in acceptable accuracy of the modified activation matrix in successive hidden layers.

According to one embodiment, 0<γₙ<1 for each hidden layer n of the N hidden layers.

The preceding one embodiment advantageously allows for random noise to be added to the activation matrix generated in all of the hidden layers to ensure privacy of the data in the modified activation matrix in each hidden layer.

According to one embodiment, γₘ=1 for at least one hidden layer m of the N hidden layers.

The preceding one embodiment advantageously avoids modifying the activation matrix generated by at the least one hidden layer m so as to avoid accuracy loss and unnecessary computation time in cases in which modifying the activation matrix in the at least one hidden layer m is not needed for protecting privacy of the data.

According to a first embodiment ξₙ is the scalar resulting from the PDF being sampled only once, and according to a second embodiment ξₙ is the matrix resulting from the PDF being sampled for each element of Aₙ.

The preceding first and second embodiments advantageously provide a flexible tradeoff between privacy of data and efficiency. The first embodiment performs only one random sampling, which increases efficiency and decreases privacy of data by adding noise that is less random than if ξₙ is the matrix of the second embodiment. The second embodiment performs multiple random samplings, namely one random sampling for each element of Aₙ, which decreases efficiency and increases privacy of data.

According to one embodiment, the PDF is a normal probability distribution, a half normal probability distribution, a Laplace probability distribution, or a half Laplace probability distribution.

The preceding one embodiment advantageously provides flexibility in the choice of a probability distribution for determining the noise ξₙ via random sampling.

Although embodiments of the present invention are described herein in terms of a large language models (LLM), such embodiments are generally applicable to a neural network hidden layer model which is defined to be a neural network model comprising one or more hidden layers.

Large language Models (LLMs) consume sensitive data as part of the deployment pipeline; e.g., inter alia, prompt tuning, Retrieval Augmented Generation (RAG), or system instructions. However, LLMs are susceptible to privacy attacks such as data extraction and Membership Inference Attack (MIA). The cost of a data leak caused by an LLM can be high for any organization deploying LLMs and/or offering an LLM deployment platform for the organization's users (e.g., members, customers, etc.). Hence, embodiments of the present invention use a plug and play mechanism for LLMs which empirically provides protection from such attacks and thus provides protection from data leakage and the exposure of confidential information (e.g., trade secrets) such as in the case of a prompt leakage attack. The inventive LLM inference provided by embodiments of the present invention does not require the modification of the LLM training process, does not change the data procurement process, and can be easily applied to any trained LLM to provide high compatibility to cases where a client desires to deploy the client's own LLM on a platform such as watsonx.ai.

The widespread use of LLMs across various applications further amplifies the risk of privacy breaches. As these LLMs are integrated into service, healthcare, and other sensitive domains, the potential for data leakage becomes a critical concern. For instance, an LLM inadvertently revealing personally identifiable information (PII) or confidential information during interactions could lead to significant privacy violations and legal repercussions.

Data leakage can be caused accidently. However, numerous attacks have been developed to extract different types of knowledge from LLMs, such as: prompt injection attacks, data extraction attacks, and membership inference attacks. Such attacks capitalize on the memorization of training data and the ability of LLMs to follow user instructions, which are difficult to control and increase the feasibility of the use of these techniques.

Embodiments of the present invention insert a module, called a Noisy Forward (NF) module, between trained LLM layers, without additional training for use of the NF module, which provides protection from privacy attacks without significantly degrading the LLM performance.

NF modules are software that can be used in any LLM architecture and do not require any training or model adjustments, which increases the usability of the NF modules.

The NF module operates on the output from an LLM layer and noises the output from the LLM layer in a unique manner. Usually, noising the output of an LLM layer will cause significant performance degradation. However, the NF module first clips the output from the LLM layers, and then replaces lost values from the output due to the clipping by using noise which facilitates retention of the original norm of the LLM output. As a result, the addition of the NF modules does not significantly reduce the performance of the LLM, while protecting the LLM from privacy attacks.

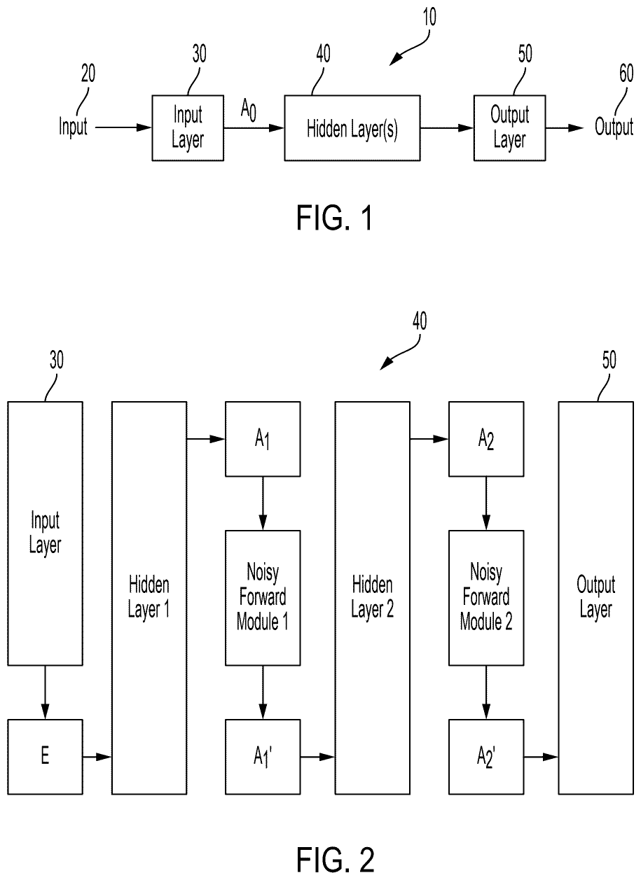

FIG. 1 depicts a LLM 10, comprising an input layer 30, hidden layers (hereinafter, “hidden layer(s)”) 40, and an output layer 50, in accordance with embodiments of the present invention.

The input layer 30 receives input 20 comprising a query that includes a sequence of tokens and converts each token to an embedding which is an embedding vector of real numbers that represent the token. A token is a unit of text such as, inter alia, a word, a sub-word, etc. The embeddings E are passed from the input layer 30 to the hidden layer(s) 40. The hidden layer(s) 40 process the embeddings E. The output from the hidden layer(s) 40 is passed to the output layer 50. The output layer 50 determines an answer to the query and outputs the answer as output 60.

The hidden layers each include a number (Cₙ) of neurons. In one embodiment, Cₙ has a same value for all hidden layers. In another embodiment, Cₙ varies among the hidden layers. Each neuron in a hidden layer receives input from neurons in the immediately preceding layer and generates output that is transmitted to neurons in the immediately following layer. Each hidden layer generates an activation matrix A consisting of Nₜ rows and Cₙ columns, wherein Nₜ is the total number tokens in the sequence of tokens (i.e., each row corresponds to a different token and each column corresponds to a different neuron). The elements of the activation matrix A are measures of semantic, syntactic or other relationships associated with the tokens in the sequence of tokens.

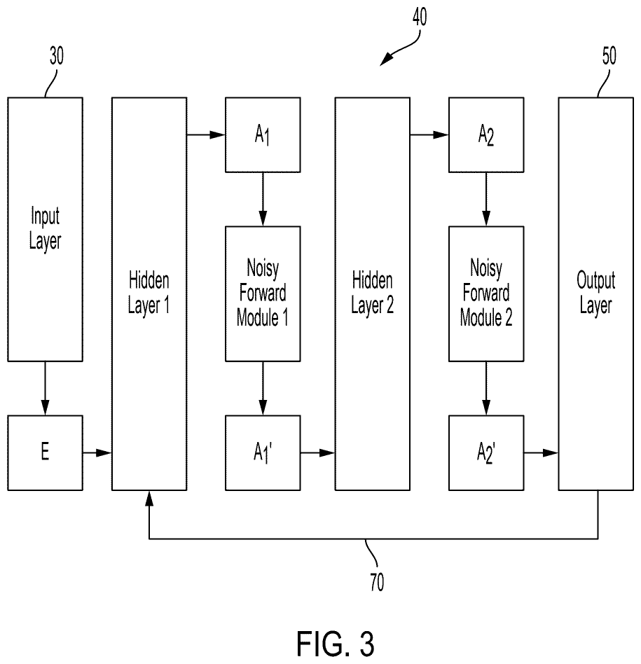

FIG. 2 depicts LLM 10 of FIG. 1 showing the hidden layer(s) 40 of the LLM 10 in greater detail, in accordance with embodiments of the present invention.

In FIG. 2, the hidden layer(s) 40 include hidden layer 1, hidden layer 2, NF module 1 disposed between hidden layer 1 and hidden layer 2, and NF module 2 disposed between hidden layer 2 and output layer 50.

Hidden layer 1 receives the embeddings E generated by the input layer 30 and generates an activation matrix A₁ from the embeddings E. NF module 1 generates a modified activation matrix A₁′ by modifying the generated activation matrix A₁ via A₁′=γ₁A₁+ξ₁ and then passes the modified activation matrix A₁′ to hidden layer 2, wherein γ₁ is a parameter satisfying 0<γ₁≤1, and wherein ξ₁ is a number randomly sampled from a probability density function (PDF) consisting of a unimodal symmetric distribution or a half unimodal symmetric distribution or is an absolute value of a number randomly sampled from a PDF consisting of the unimodal symmetric distribution. The unimodal symmetric distribution (also called a full unimodal symmetric distribution) has a mean of zero and a spread that is a monotonically decreasing function of (1−γ₁) such that the spread approaches zero as γ₁ approaches 1. The special case of γ₁=1 results in A₁′=A₁ with A₁ not being modified by NF module 1.

Hidden layer 2 receives the modified activation matrix A₁′ from hidden layer 1 and generates an activation matrix A₂ from the modified activation matrix A₁′. NF module 2 generates a modified activation matrix A₂′ by modifying the generated activation matrix A₂ via A₂′=γ₂A₂+ξ₂ and then passes the modified activation matrix A₂′ to output layer 50, wherein γ₂ is a parameter satisfying 0<γ₂≤1, and wherein ξ₂ is a number randomly sampled from a probability density function (PDF) consisting of a unimodal symmetric distribution or a half unimodal symmetric distribution or is an absolute value of a number randomly sampled from a PDF consisting of the unimodal symmetric distribution. The unimodal symmetric distribution has a mean of zero and a spread that is a monotonically decreasing function of (1−γ₂) such that the spread approaches zero as γ₂ approaches 1. The special case of γ₂=1 results in A₂′=A₂ with A₂ not being modified by NF module 2.

Generally, the hidden layer(s) 40 consist of N hidden layers, wherein N≥1. In FIG. 2, N=2.

It is required that at least one hidden layer m of the N hidden layers satisfy γₘ<1.

For example, if γ₁=1 and γ₂<1 in FIG. 2, the modified activation matrix A₁′=A₁ would be passed to hidden layer 2.

As another example, if γ₁<1 and γ₂=1 in FIG. 2, the modified activation matrix A₂′=A₂ would be passed to output layer 50.

In one embodiment, γ₁=γ₂=γ, wherein γ is a same parameter for all hidden layers.

For any hidden layer, let A denote the activation matrix output by the hidden layer and let A′ denote the modified activation matrix generated by the NF module by performing a norm clipping operation on A to generate a clipped matrix A_{c}, followed by a noising operation that noises A by generating noise ξ, followed by computing A′ via A′=A_{c}+ξ, wherein ξ is a number randomly sampled from a probability density function (PDF) consisting of a unimodal symmetric distribution or a half unimodal symmetric distribution, or is an absolute value of a number randomly sampled from a PDF consisting of the unimodal symmetric distribution. The unimodal symmetric distribution has a mean of zero and may be a normal distribution, a Laplace distribution, a Cauchy distribution, etc. A half unimodal symmetric distribution is a unimodal symmetric distribution F(x) that has been modified such that F(x)=0 if x<0. ξ is either a scalar resulting from ξ being sampled only once from the PDF or a matrix resulting from ξ being sampled from the PDF once for each element of A. The unimodal symmetric distribution has a spread that is a monotonically decreasing function of (1−γ) such that the spread approaches zero as γ approaches 1. The special case of γ=1 results in A′=A with A not being modified by NF module.

The clipped matrix A_{c} is computed via A_{c}=γA, wherein γ is a parameter that multiplies each element of the matrix A, wherein γ is in a range of 0<γ≤1.

In one embodiment, γ has a value that reduces the A by a negligent amount (e.g., γ=0.95, 0.96, 0.97, 0.975, 0.98, 0.99, 0.995).

In one embodiment, γ has a same constant value among all of the hidden layers whose outputted activation matrix is clipped by an NF module.

In one embodiment, γ has a value that varies among the hidden layers whose outputted activation matrix is clipped by an NF module. For example, in one embodiment, γ increases monotonically from the first hidden layer (closest to the input layer) to the last hidden layer (closest to the output layer), in order to compensate for the loss of accuracy due to the clipping as the hidden layers are modified by an NF module going from the first hidden layer to the last hidden layer.

The noising operation determines the noise ξ as a number randomly sampled from a probability density function (PDF) consisting of a unimodal symmetric distribution or a half unimodal symmetric distribution or is an absolute value of a number randomly sampled from a PDF consisting of the unimodal symmetric distribution. The unimodal symmetric distributions may be, inter alia, a normal distribution, a Laplace distribution, a Cauchy distribution, etc. The unimodal symmetric distributions used by embodiments of the present invention have a single peak at the mean of zero at a central location of the distribution, are symmetric about the central location, and have a bell-shaped or sharp peak profile.

The unimodal symmetric distribution depends on the product |A|_{f}·(1−γ), wherein |⋅|_{f} denotes a frobenius norm.

For performing the operation of A′=A_{c}+ξ: (i) in one embodiment ξ is equal to the absolute value of a number randomly sampled once and is a same value added to each element of A_{c} to compute A′ and (ii) in one embodiment ξ is equal to the absolute value of a number randomly sampled separately for each element of A and is thus a matrix of random values that is added to respective values of A_{c} to compute A′.

For the normal distribution, ξ is the absolute value of a number randomly sampled from

$$N ( μ = 0 , σ = \frac{{\vert A \vert}_{f} \cdot ( 1 - γ )}{2 \cdot Sqrt ( {N}_{t} \cdot {D}_{e} )} ) ,$$

wherein μ is the mean and σ is the standard deviation which controls the spread of the normal distribution and is proportional to |A|_{f}(1−γ). Nₜ is the total number tokens in the sequence of tokens and Dₑ is the number of elements in each embedding vector.

For the normal distribution, the following discussion derives an upper bound UB2σ of the norm of A′ at 2 standard deviations (i.e., 2σ) above the mean μ which corresponds to a 95% probability.

$$\begin{matrix}UB 2 σ = {\vert {A}^{′} + 2 \cdot std \vert}_{f} \\ = {\vert γ \cdot A + 2 \cdot \frac{{\vert A \vert}_{f} \cdot ( 1 - γ )}{2 \cdot Sqrt ( {N}_{t} \cdot {D}_{e} )} \vert}_{f} \leq {\vert γ \cdot A \vert}_{f} + {\vert 2 \cdot \frac{{\vert A \vert}_{f} \cdot ( 1 - γ )}{2 \cdot Sqrt ( {N}_{t} \cdot {D}_{e} )} \vert}_{f} \\ = γ \cdot {\vert A \vert}_{f} + s q r t ( {N}_{t} \cdot {D}_{e} ) \cdot {\vert A \vert}_{f} ( 1 - γ ) \cdot \frac{2}{2 \cdot sqrt ( {N}_{t} \cdot {D}_{e} )} \\ = γ \cdot {\vert A \vert}_{f} + ( 1 - γ ) \cdot {\vert A \vert}_{f} \\ = {\vert A \vert}_{f}\end{matrix} \qquad ( 1 )$$

In equation (1), std is the standard deviation σ, and the inequality ≤ is a triangle inequality for vectors.

The norm of a matrix in which all of the entries in the matrix are a scalar b times a norm of a matrix A∈R^{d}^{₁}^{×d}^{_{z}} is \sqrt{d₁·d₂}·|A|·|b|.

For the normal distribution, the following discussion derives a lower bound LB2σ of the norm of A′ at 2 standard deviations (i.e., 2σ) below the mean μ which corresponds to a 95% probability.

$$\begin{matrix}LB 2 σ = {\vert {A}^{′} - 2 \cdot std \vert}_{f} \\ = {\vert γ \cdot A - 2 \cdot \frac{{\vert A \vert}_{f} \cdot ( 1 - γ )}{2 \cdot Sqrt ( {N}_{t} \cdot {D}_{e} )} \vert}_{f} \geq \vert {\vert γ \cdot A \vert}_{f} - \vert 2 \cdot \frac{{\vert A \vert}_{f} \cdot ( 1 - γ )}{2 \cdot Sqrt ( {N}_{t} \cdot {D}_{e} )} \vert \vert \\ = \vert γ \cdot {\vert A \vert}_{f} - sqr t ( {N}_{t} \cdot {D}_{e} ) \cdot {\vert A \vert}_{f} ( 1 - γ ) \cdot \frac{2}{2 \cdot sqrt ( {N}_{t} \cdot {D}_{e} )} \vert \\ = \vert γ \cdot {\vert A \vert}_{f} - ( 1 - γ ) \cdot {\vert A \vert}_{f} \\ = \vert ( 2 \cdot γ - 1 ) \cdot {\vert A \vert}_{f} \vert\end{matrix} \qquad ( 2 )$$

In equation (2), std is the standard deviation σ, and the inequality ≥ is a reverse triangle inequality for vectors.

The Laplace probability density function (PDF) is f(x|μ, b)=(½b) exp(−|x−μ|/b) which particularizes to Laplace

$$( μ = 0 , b = \frac{{\vert A \vert}_{f} \cdot ( 1 - γ )}{3 \cdot Sqrt ( {N}_{t} \cdot {D}_{e} )} )$$

for implementation of embodiments of the present invention.

Similar to the normal distribution, the Laplace distribution is parametrized by two variables: the mean μ and the scale b which controls the spread of the distribution via the exponential attenuation exp (−|x−u|/b), where b is analogous to the standard deviation σ for a normal distribution and is proportional to the product |A|_{f}·(1−γ). The scale variable b is similar to the standard deviation σ used in the normal distribution, except that 3 is in the denominator for the Laplace distribution instead of 2 in the denominator for the normal distribution.

The following discussion explains how the Laplace distribution is used.

The cumulative distribution function (CDF) for the Laplace distribution is:

$$F ( x \vert μ , b ) = \{ \begin{matrix}\frac{1}{2} \cdot {e}^{\frac{x - μ}{b}} & if x < μ \\ 1 - \frac{1}{2} \cdot {e}^{\frac{x - μ}{b}} & if x \geq μ\end{matrix}$$

The probability P(|X−μ|<k·b) that a random variable X falls within [μ−k·b, μ+k·b] is governed by Equation (3).

$$P ( \vert X - μ \vert < k \cdot b ) = F ( μ + k \cdot b ) - F ( μ - k \cdot b ) \qquad ( 3 )$$

Equation (3) simplifies to P(|X−μ|<k·b)=1−e^{-k}

Thus, for k=3 (i.e., 3·b), P(|X−μ|≤3b)=1−e⁻³≈0.95.

The standard deviation (σ) of the normal distribution and the scale (b) of the Laplace distribution each control the spread of the distribution and are each is proportional to the product |A|_{f}·(1−γ). Thus, if γ=1 then A_{c}=A and ξ=0 (since σ=0 and b=0), so that A′=A_{c}+ξ=A and therefore the NF module does not modify A if γ=1.

Also, as γ increases, A_{c}=γA increases and |A|_{f}(1−γ) decreases proportionately causing ξ to decrease, which explains why the magnitude of A′, which equals A_{c}+ξ, deviates negligibly from the magnitude of A if γ is sufficiently close to 1.

The preceding formalism, which involves computing a modified activation matrix A′ at each hidden layer by clipping and noising the activation matrix A generated by each hidden layer, can be used for either training the LLM 10 or for performing inference using the trained LLM 10.

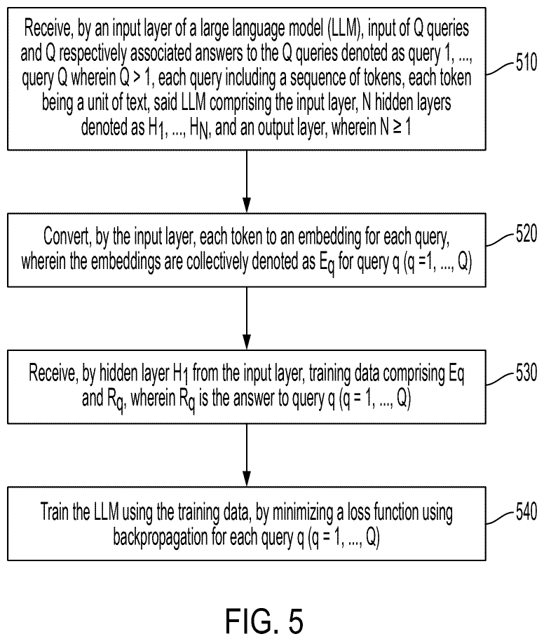

The description supra of FIG. 2 is applicable to performing inference using the trained LLM 10. In FIG. 2, the input layer 30 receives one query as input, and the one query is processed as described supra. FIG. 5, presented infra, describes performance of the inference, using the LLM 10, in more detail.

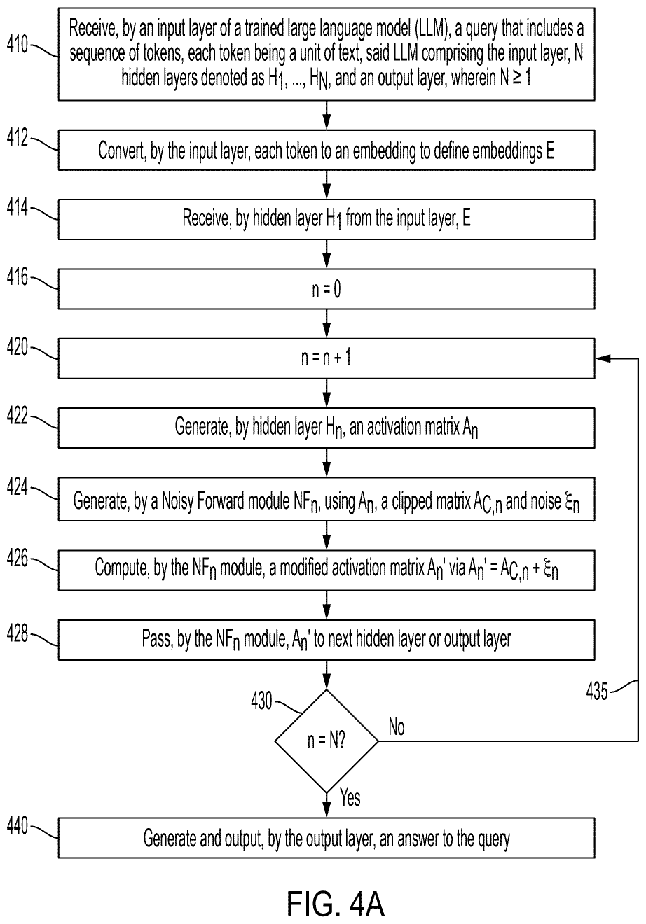

FIG. 3 depicts a modification of using the LLM 10 in FIG. 2 for training the LLM 10, in accordance with embodiments of the present invention.

In FIG. 3, the input layer 30 receives Q queries and Q respective answers R₁, . . . , R_{Q} as input wherein Q≥2. The input layer 30 converts each token to an embedding for each query of the Q queries, wherein the embeddings are collectively denoted as E_{q} for query q (q=1, . . . , Q) resulting in generation of Q embeddings respectively associated with the Q queries. Then input layer 30 passes training data to hidden layer 1, wherein the training data comprises E_{q} and R_{q} for q=1, . . . , Q.

The loop 70 pertains to an iterative process in which Q iterations are performed, wherein iteration q processes query q as discussed supra (q=1, . . . , Q).

FIGS. 5, 6A, 6B, and 7, presented infra, describes performance of the training of the LLM 10 in more detail.

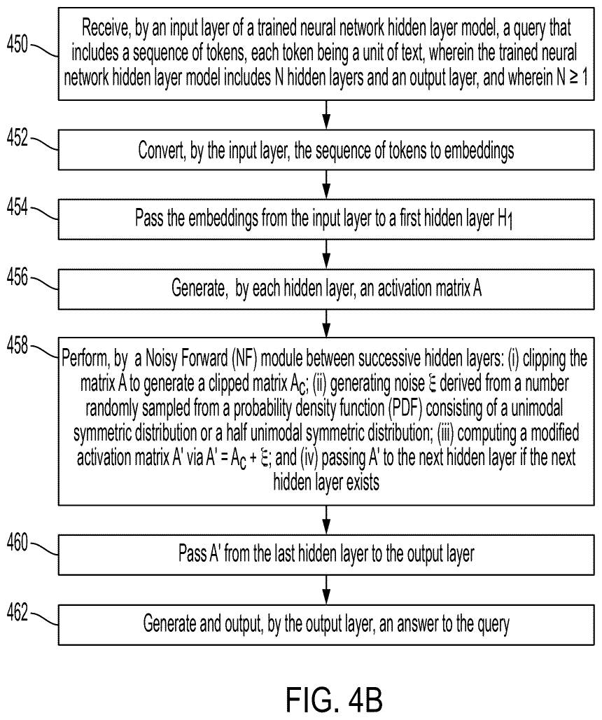

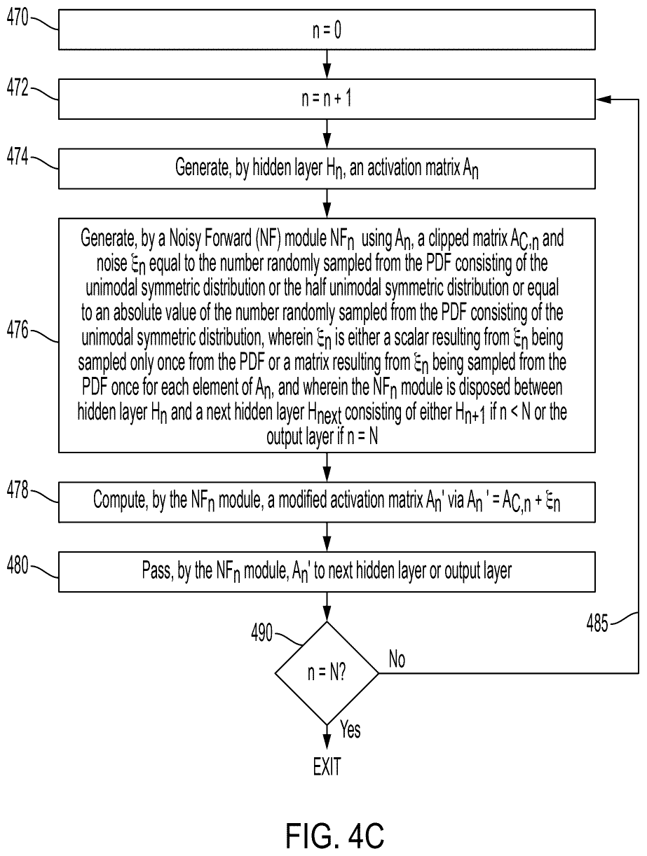

FIG. 4A is a flow chart of a method for performing inference using a trained large language model (LLM), in accordance with embodiments of the present invention. The method of FIG. 4A includes steps 410-440.

Step 410 receives, by an input layer of a trained large LLM, a query that includes a sequence of tokens, each token being a unit of text, said LLM comprising the input layer, N hidden layers denoted as H₁, . . . , H_{N}, and an output layer, wherein N≥1.

Step 412 converts, by the input layer, each token to an embedding, wherein the embeddings are collectively denoted as E.

Step 414 receives, by hidden layer H₁ from the input layer, E.

Steps 416-440 constitute an iterative process of N iterations defined by a loop 435 that loops over the hidden layers denoted by a hidden layer index n (n=1, . . . , N).

Step 416 sets the hidden layer index n to zero.

Step 420 increments n by 1.

Step 422 generates, by hidden layer Hₙ, an activation matrix Aₙ.

Step 424 generates, by a Noisy Forward (NF) module NFₙ using Aₙ, a clipped matrix A_{C,n} and noise ξₙ equal to a number randomly sampled from a probability density function (PDF) consisting of a unimodal symmetric distribution or a half unimodal symmetric distribution or equal to an absolute value of a number randomly sampled from a PDF consisting of the unimodal symmetric distribution, wherein ξₙ is either a scalar resulting from ξₙ being the absolute value of a number randomly sampled only once from the PDF or a matrix resulting from ξₙ being the absolute value of a number randomly sampled from the PDF once for each element of Aₙ, and wherein the NFₙ module is disposed between hidden layer Hₙ and either a hidden layer Hₙₑₓₜ consisting of either Hₙ₊₁ if n<N or the output layer if n=N.

Step 426 computes, by the NFₙ module, a modified activation matrix Aₙ′ via Aₙ′=A_{C,n}+ξₙ.

Step 428 passes, by the NFₙ module, Aₙ′ to Hₙₑₓₜ.

Step 430 determines whether n=N. If so (Yes branch from step 430) then step 440 is next executed. If not (No branch from step 430) then processing loops back to step 420 to perform the next iteration n+1.

Step 440 generates and outputs, by the output layer, an answer to the query.

In one embodiment, generating A_{C,n} in step 424 comprises computing A_{C,n} via A_{C,n}=γₙAₙ, wherein γₙ is a parameter that has a scalar value, and wherein the PDF includes a dependence on (1−γₙ) that controls a spread of the PDF. This one embodiment provides a technical feature of replacing a portion of the activation matrix at each hidden layer with randomly generated noise, in a manner that protects the privacy of the data in the activation matrix while preserving the accuracy of the activation matrix during performance of inference using the LLM.

In a first embodiment N≥2 and γₙ is a constant whose value is independent of n (n=1, . . . , N), and in a second embodiment N≥2 and γₙ varies with respect to n (n=1, . . . , N), and in a special case, γ₁< . . . <γ_{N} (e.g., N=3, γ₁=0.950, γ₂=0.960, γ₃=0.98). The preceding first and second embodiments advantageously provide flexible use and tailoring of the parameter γₙ. For example, the constant value γ may be suitable if γ is at least a threshold value γₜₕ (e.g., 0.95, 0.975) such that there is negligible attenuation if the modified activation matrix in successive hidden layers. However, if γ is less than γₜₕ, then the attenuation of the activation matrix in successive hidden layers may result in unacceptable loss in accuracy in the modified activation matrix and implementation of γ₁< . . . <γ_{N} may enable acceptable accuracy in the modified activation matrix in successive hidden layers.

In one embodiment, γₙ is in a range of 0.95≤γₙ≤1 for n=1, . . . , N. The preceding one embodiment advantageously specifies values of γₙ sufficiently close to 1 so that the small attenuation (5% or less) of the modified activation matrix in successive hidden layers results in acceptable accuracy of the modified activation matrix in successive hidden layers.

In one embodiment, 0<γₙ<1 for each hidden layer n of the N hidden layers. The preceding one embodiment advantageously allows for random noise to be added to the activation matrix generated in all of the hidden layers to ensure privacy of the data in the modified activation matrix in each hidden layer.

In one embodiment, γₘ=1 for at least one hidden layer m of the N hidden layers. The preceding one embodiment advantageously avoids modifying the activation matrix generated by at the least one hidden layer m so as to avoid accuracy loss and unnecessary computation time in cases in which modifying the activation matrix in the at least one hidden layer m is not needed for protecting privacy of the data.

In a first embodiment, ξₙ is the scalar resulting from the PDF being sampled only once, and in a second embodiment ξₙ is the matrix resulting from the PDF being sampled once for each element of Aᵢ. The preceding first and second embodiments advantageously provide a flexible tradeoff between privacy of data and efficiency. The first embodiment performs only one random sampling, which increases efficiency and decreases privacy of data by adding noise that is less random than if ξₙ is the matrix of the second embodiment. The second embodiment performs multiple random samplings, namely one random sampling for each element of Aₙ, which decreases efficiency and increases privacy of data.

In one embodiment, the PDF is a normal probability distribution, a half normal probability distribution, a Laplace probability distribution, or a half Laplace probability distribution. The preceding one embodiment advantageously provides flexibility in the choice of a probability distribution for determining the noise ξₙ via random sampling.

FIGS. 4B and 4C are flow charts collectively providing an alternative description of the method of FIG. 4A, in accordance with embodiments of the present invention.

The method of FIG. 4B includes steps 450-462.

Step 450 receives, by an input layer of a trained neural network hidden layer model, a query that includes a sequence of tokens, each token being a unit of text, wherein the trained neural network hidden layer model includes N hidden layers and an output layer, and wherein N≥1.

Step 452 converts, by the input layer, the sequence of tokens to embeddings.

Step 454 passes the embeddings from the input layer to a first hidden layer H₁.

Step 456 generates, by each hidden layer, an activation matrix A.

Step 458 performs, by a Noisy Forward (NF) module between successive hidden layers: (i) clipping the matrix A to generate a clipped matrix A_{c}; (ii) generating noise ξ derived from a number randomly sampled from a probability density function (PDF) consisting of a unimodal symmetric distribution or a half unimodal symmetric distribution; (iii) computing a modified activation matrix A′ via A′=A_{c}+ξ; and (iv) passing A′ to the next hidden layer if the next hidden layer exists.

Step 460 passes A′ from the last hidden layer to the output layer.

Step 462 generates and outputs, by the output layer, an answer to the query.

FIG. 4C is a flow chart of a process that describes steps 456, 458 and 480 of FIG. 4B in greater detail with respect to processing the N hidden layers for query q, in accordance with embodiments of the present invention.

The process of FIG. 4C, which includes steps 470-490, is an iterative process defined by a loop 485 that loops over the N hidden layers, wherein each iteration of the iterative process is characterized by an iteration index n.

Step 470 set the iteration index n to zero.

Step 472 increments n by 1.

Step 474 generates, by hidden layer Hₙ, an activation matrix Aₙ.

Step 476 generates, by a Noisy Forward (NF) module NFₙ using Aₙ, a clipped matrix A_{C,n} and noise ξₙ equal to the number randomly sampled from the PDF consisting of the unimodal symmetric distribution or the half unimodal symmetric distribution or equal to an absolute value of the number randomly sampled from the PDF consisting of the unimodal symmetric distribution, wherein ξₙ is either a scalar resulting from ξₙ being sampled only once from the PDF or a matrix resulting from ξₙ being sampled from the PDF once for each element of Aₙ, and wherein the NFₙ module is disposed between hidden layer Hₙ and a next hidden layer Hₙₑₓₜ consisting of either Hₙ₊₁ if n<N or the output layer if n=N.

Step 478 computes, by the NFₙ module, a modified activation matrix Aₙ′ via Aₙ′=A_{C,n}+ξₙ. If ξₙ results from randomly sampling the PDF only once, then the same value of ξₙ resulting from the random sampling is added to each element of the matrix A_{C,n}. If ξₙ results from sampling the PDF once for each element of Aₙ, then the ξₙ matrix whose elements have different values is added to the matrix A_{C,n}.

Step 480 passes, by the NFₙ module, Aₙ′ to Hₙₑₓₜ.

Step 490 determines whether n=N. If so (Yes branch from step 490) then the process exits. If not (No branch from step 490) then processing loops back to step 472 to perform the next iteration n+1.

FIG. 5 is a flow chart of a method for training a large language model (LLM), in accordance with embodiments of the present invention. The method of FIG. 5 includes steps 510-540.

Step 510 receives, by an input layer of the large language model (LLM), input of Q queries and Q respectively associated answers to the Q queries denoted as query 1, . . . , query Q wherein Q>1, each query including a sequence of tokens, each token being a unit of text, said LLM comprising the input layer, N hidden layers denoted as H₁, . . . , H_{N}, and an output layer, wherein N≥1

Step 520 converts, by the input layer, each token to an embedding for each query, wherein the embeddings are collectively denoted as E_{q} for query q (q=1, . . . , Q).

Step 530 receives, by hidden layer H₁ from the input layer, training data comprising E_{q} and R_{q}, wherein R_{q} is the answer to query q (q=1, . . . , Q).

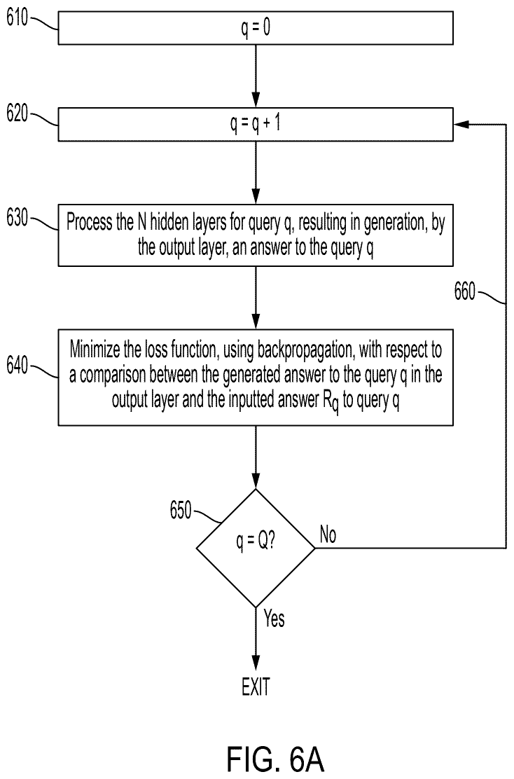

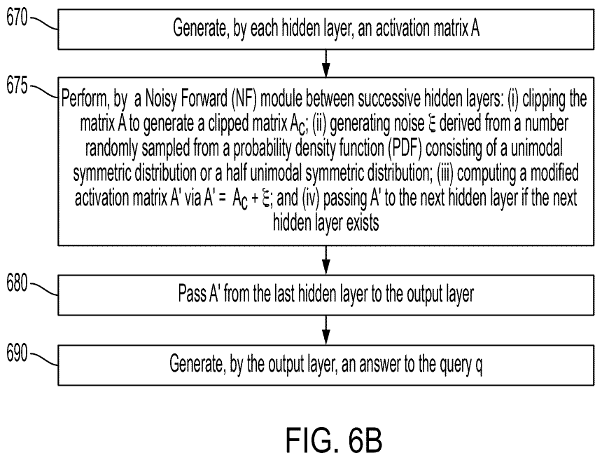

Step 540 trains the LLM using the training data, by minimizing a loss function using backpropagation for each query q (q=1, . . . , Q). FIG. 6A describes step 540 in greater detail.

FIG. 6A is a flow chart of a process that performs the training step 540 of FIG. 5 in more detail, in accordance with embodiments of the present invention.

The process of FIG. 6A, which includes steps 610-650, is an iterative process defined by a loop 660 that loops over the Q queries wherein each iterative of the iterative process is characterized by an iteration index q.

Step 610 sets the iteration index q to zero.

Step 620 increments q by 1.

Step 630 processes the N hidden layers for query q, resulting in generation, by the output layer, of an answer to the query q. FIG. 6B describes step 630 in greater detail.

Step 640 minimizes the loss function, using backpropagation, with respect to a comparison between the generated answer to the query q in the output layer and the inputted answer R_{q} to query q.

Step 650 determines whether q=Q. If so (Yes branch from step 650) then the process exits. If not (No branch from step 650) then processing loops back to step 620 to perform the next iteration q+1.

FIG. 6B is a flow chart describing the processing of N hidden layers in step 630 of FIG. 6A in more detail, in accordance with embodiments of the present invention. The flow chart of FIG. 6B includes steps 670-690.

Step 670 generates, by each hidden layer, an activation matrix A.

Step 675 performs, by a Noisy Forward (NF) module between successive hidden layers: (i) clipping the matrix A to generate a clipped matrix A_{c}; (ii) generating noise ξ derived from a number randomly sampled from a probability density function (PDF) consisting of a unimodal symmetric distribution or a half unimodal symmetric distribution; (iii) computing a modified activation matrix A′ via A′=A_{c}+ξ; and (iv) passing A′ to the next hidden layer if the next hidden layer exists.

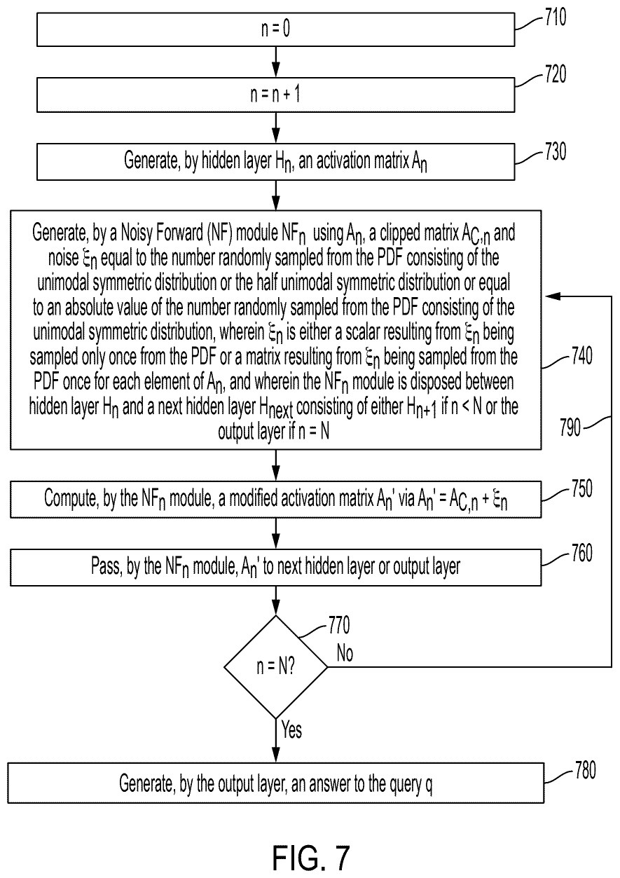

Step 680 passes A′ from the last hidden layer to the output layer. FIG. 7 describes step 630 in greater detail.

Step 690 generates, by the output layer, an answer to the query q.

FIG. 7 is a flow chart of a process that describes, in more detail, the process described in FIG. 6B that processes the N hidden layers for query q, in accordance with embodiments of the present invention.

The process of FIG. 7, which includes steps 710-780, is an iterative process defined by a loop 790 that loops over the N hidden layers, wherein each iteration of the iterative process is characterized by an iteration index n.

Step 710 set the iteration index n to zero.

Step 720 increments n by 1

Step 730 generates, by hidden layer Hₙ, an activation matrix Aₙ.

Step 740 generates, by a Noisy Forward (NF) module NFₙ using Aₙ, a clipped matrix A_{C,n} and noise ξₙ equal to a number randomly sampled from the PDF consisting of the unimodal symmetric distribution or the half unimodal symmetric distribution or equal to an absolute value of a number randomly sampled from the PDF consisting of the unimodal symmetric distribution, wherein ξₙ is either a scalar resulting from ξₙ being the absolute value of a number randomly sampled only once from the PDF or a matrix resulting from ξₙ being the absolute value of a number randomly sampled from the PDF once for each element of Aₙ, and wherein the NFₙ module is disposed between hidden layer Hₙ and a next hidden layer Hₙₑₓₜ consisting of either Hₙ₊₁ if n<N or the output layer if n=N.

Step 750 computes, by the NFₙ module, a modified activation matrix Aₙ′ via Aₙ′=A_{C,n}+ξₙ. If ξₙ is the absolute value of a number randomly sampled only once from the PDF, then the same value of ξₙ resulting from the random sampling is added to each element of the matrix A_{C,n}. If ξₙ is the absolute value of a number randomly sampled from the PDF once for each element of Aₙ, then the ξₙ matrix whose elements have different values is added to the matrix A_{C,n}.

Step 760 passes, by the NFₙ module, Aₙ′ to Hₙₑₓₜ.

Step 770 determines whether n=N. If so (Yes branch from step 770) then step 780 is next executed. If not (No branch from step 770) then processing loops back to step 720 to perform the next iteration n+1.

In one embodiment, generating A_{C,n} in step 740 comprises computing A_{C,n} via A_{C,n}=γₙAₙ, wherein γₙ is a parameter that has a scalar value, and wherein the PDF includes a dependence on (1−γₙ) that controls a spread of the PDF. This one embodiment provides a technical feature of replacing a portion of the activation matrix at each hidden layer with randomly generated noise, in a manner that protects the privacy of the data in the activation matrix while preserving the accuracy of the activation matrix during performance of inference using the LLM.

In a first embodiment N≥2 and γₙ is a constant whose value is independent of n (n=1, . . . , N), and in a second embodiment N≥2 and γₙ varies with respect to n (n=1, . . . , N) and in a special case, γ₁< . . . <γ_{N} (e.g., N=4, γ₁=0.94, γ₂=0.95, γ₃=0.97, γ₃=1.0). The preceding first and second embodiments advantageously provide flexible use and tailoring of the parameter γₙ. For example, the constant value γ may be suitable if γ is at least a threshold value γₜₕ (e.g., 0.95, 0.975) such that there is negligible attenuation if the modified activation matrix in successive hidden. However, if γ is less than γₜₕ, then the attenuation of the activation matrix in successive hidden layers may result in unacceptable loss in accuracy in the modified activation matrix and implementation of γ₁< . . . <γ_{N} may enable acceptable accuracy in the modified activation matrix in successive hidden layers.

In one embodiment, γₙ is in a range of 0.95≤γₙ≤1 for n=1, . . . , N. The preceding one embodiment advantageously specifies values of γₙ sufficiently close to 1 so that the small attenuation (5% or less) of the modified activation matrix in successive hidden layers results in acceptable accuracy of the modified activation matrix in successive hidden layers.

In one embodiment, 0<γₙ<1 for each hidden layer n of the N hidden layers. The preceding one embodiment advantageously allows for random noise to be added to the activation matrix generated in all of the hidden layers to ensure privacy of the data in the modified activation matrix in each hidden layer.

In one embodiment, γₘ=1 for at least one hidden layer m of the N hidden layers. The preceding one embodiment advantageously avoids modifying the activation matrix generated by at the least one hidden layer m so as to avoid accuracy loss and unnecessary computation time in cases in which modifying the activation matrix in the at least one hidden layer m is not needed for protecting privacy of the data.

In a first embodiment, ξₙ is the scalar resulting from the PDF being sampled only once, and in a second ξₙ is the matrix resulting from the PDF being sampled once for each element of Aᵢ. The preceding first and second embodiments advantageously provide a flexible tradeoff between privacy of data and efficiency. The first embodiment performs only one random sampling, which increases efficiency and decreases privacy of data by adding noise that is less random than if ξₙ is the matrix of the second embodiment. The second embodiment performs multiple random samplings, namely one random sampling for each element of Aₙ, which decreases efficiency and increases privacy of data.

In one embodiment, the PDF is a normal probability distribution, a half normal probability distribution, a Laplace probability distribution, or a half Laplace probability distribution. The preceding one embodiment advantageously provides flexibility in the choice of a probability distribution for determining the noise ξₙ via random sampling.

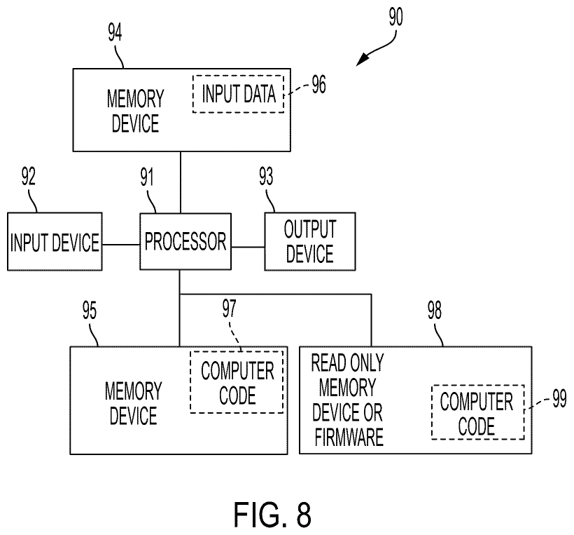

FIG. 8 illustrates a computer system 90, in accordance with embodiments of the present invention.

The computer system 90 includes a processor 91, an input device 92 coupled to the processor 91, an output device 93 coupled to the processor 91, and memory devices 94 and 95 each coupled to the processor 91. The processor 91 represents one or more processors and may denote a single processor or a plurality of processors. The input device 92 may be, inter alia, a keyboard, a mouse, a camera, a touchscreen, etc., or a combination thereof. The output device 93 may be, inter alia, a printer, a plotter, a computer screen, a magnetic tape, a removable hard disk, a floppy disk, etc., or a combination thereof. The memory devices 94 and 95 may each be, inter alia, a hard disk, a floppy disk, a magnetic tape, an optical storage such as a compact disc (CD) or a digital video disc (DVD), a dynamic random access memory (DRAM), a read-only memory (ROM), etc., or a combination thereof. The memory device 95 includes a computer code 97. The computer code 97 includes algorithms for executing embodiments of the present invention. The processor 91 executes the computer code 97. The memory device 94 includes input data 96. The input data 96 includes input required by the computer code 97. The output device 93 displays output from the computer code 97. Either or both memory devices 94 and 95 (or one or more additional memory devices such as read only memory device 96) may include algorithms and may be used as a computer usable medium (or a computer readable medium or a program storage device) having a computer readable program code embodied therein and/or having other data stored therein, wherein the computer readable program code includes the computer code 97. Generally, a computer program product (or, alternatively, an article of manufacture) of the computer system 90 may include the computer usable medium (or the program storage device).

In some embodiments, rather than being stored and accessed from a hard drive, optical disc or other writeable, rewriteable, or removable hardware memory device 95, stored computer program code 99 (e.g., including algorithms) may be stored on a static, nonremovable, read-only storage medium such as a Read-Only Memory (ROM) device 98, or may be accessed by processor 91 directly from such a static, nonremovable, read-only medium 98. Similarly, in some embodiments, stored computer program code 99 may be stored as computer-readable firmware, or may be accessed by processor 91 directly from such firmware, rather than from a more dynamic or removable hardware data-storage device 95, such as a hard drive or optical disc.

Still yet, any of the components of the present invention could be created, integrated, hosted, maintained, deployed, managed, serviced, etc. by a service supplier who offers to improve software technology associated with cross-referencing metrics associated with plug-in components, generating software code modules, and enabling operational functionality of target cloud components. Thus, the present invention discloses a process for deploying, creating, integrating, hosting, maintaining, and/or integrating computing infrastructure, including integrating computer-readable code into the computer system 90, wherein the code in combination with the computer system 90 is capable of performing a method for enabling a process for improving software technology associated with cross-referencing metrics associated with plug-in components, generating software code modules, and enabling operational functionality of target cloud components. In another embodiment, the invention provides a business method that performs the process steps of the invention on a subscription, advertising, and/or fee basis. That is, a service supplier, such as a Solution Integrator, could offer to enable a process for improving software technology associated with cross-referencing metrics associated with plug-in components, generating software code modules, and enabling operational functionality of target cloud components. In this case, the service supplier can create, maintain, support, etc. a computer infrastructure that performs the process steps of the invention for one or more customers. In return, the service supplier can receive payment from the customer(s) under a subscription and/or fee agreement and/or the service supplier can receive payment from the sale of advertising content to one or more third parties.

While FIG. 8 shows the computer system 90 as a particular configuration of hardware and software, any configuration of hardware and software, as would be known to a person of ordinary skill in the art, may be utilized for the purposes stated supra in conjunction with the particular computer system 90 of FIG. 8. For example, the memory devices 94 and 95 may be portions of a single memory device rather than separate memory devices.

A computer program product of the present invention comprises one or more computer readable hardware storage devices having computer readable program code stored therein, said program code containing instructions executable by one or more processors of a computer system to implement the methods of the present invention.

A computer system of the present invention comprises one or more processors, one or more memories, and one or more computer readable hardware storage devices, said one or more hardware storage devices containing program code executable by the one or more processors via the one or more memories to implement the methods of the present invention.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

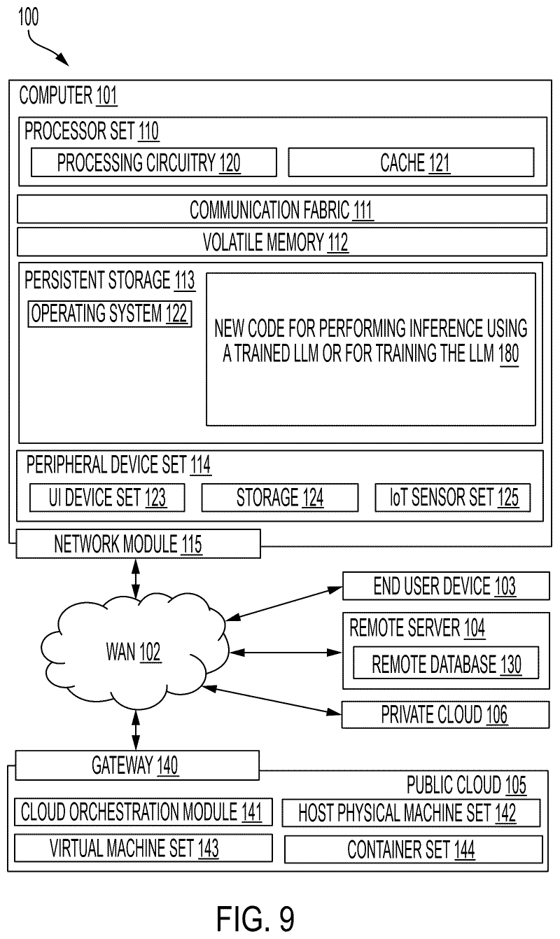

FIG. 9 depicts a computing environment 100 which contains an example of an environment for the execution of at least some of the computer code involved in performing the inventive methods, in accordance with embodiments of the present invention. Such computer code includes new code for performing inference using a trained large language model (LLM) or for training the LLM 180. In addition to block 180, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 180, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 180 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 180 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

CLOUD COMPUTING SERVICES AND/OR MICROSERVICES (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method, said method comprising:
receiving, by an input layer of a trained neural network hidden layer model, a query that includes a sequence of tokens, each token being a unit of text, wherein the trained neural network hidden layer model includes N hidden layers and an output layer, and wherein N≥1;
converting, by the input layer, the sequence of tokens to embeddings;
passing the embeddings from the input layer to a first hidden layer H₁;
generating, by each hidden layer, an activation matrix A;
performing, by a Noisy Forward (NF) module between successive hidden layers: (i) clipping the matrix A to generate a clipped matrix A_{c}; (ii) generating noise ξ derived from a number randomly sampled from a probability density function (PDF) consisting of a unimodal symmetric distribution or a half unimodal symmetric distribution; (iii) computing a modified activation matrix A′ via A′=A_{c}+ξ; and (iv) passing A′ to a next hidden layer if the next hidden layer exists;
passing A′ from a last hidden layer to the output layer; and
generating and outputting, by the output layer, an answer to the query.

2. The method of claim 1, wherein the hidden layers are denoted as H₁, . . . , H_{N}, and wherein said generating by each hidden layer the activation matrix A, said performing by the Noisy Forward module, and said passing A′ comprise:
$$for n = 1 , … , N :$$
(i) generating, by hidden layer Hₙ, an activation matrix Aₙ,
(ii) generating, by a Noisy Forward (NF) module NFₙ using Aₙ, a clipped matrix A_{C,n} and noise ξₙ equal to the number randomly sampled from the PDF consisting of the unimodal symmetric distribution or the half unimodal symmetric distribution or equal to an absolute value of the number randomly sampled from the PDF consisting of the unimodal symmetric distribution, wherein ξₙ is either a scalar resulting from ξₙ being sampled only once from the PDF or a matrix resulting from ξₙ being sampled from the PDF once for each element of Aₙ, and wherein the NFₙ module is disposed between hidden layer Hₙ and a next hidden layer Hₙₑₓₜ consisting of either Hₙ₊₁ if n<N or the output layer if n=N,
(iii) computing, by the NFₙ module, a modified activation matrix Aₙ′ via Aₙ′=A_{C,n}+ξₙ;
(iv) passing, by the NFₙ module, Aₙ′ to Hₙₑₓₜ.

3. The method of claim 2, wherein said generating A_{C,n} comprises computing A_{C,n} via A_{C,n}=γₙAₙ, wherein γₙ is a parameter that has a value in a range of 0<γₙ≤1 subject to γₙ<1 being satisfied for at least one hidden layer n of the N hidden layers, and wherein the PDF includes a dependence on (1−γₙ) that controls a spread of the PDF.

4. The method of claim 3, wherein N≥2, and wherein γₙ is a constant whose value γ is independent of n (n=1, . . . , N).

5. The method of claim 3, wherein N≥2, and wherein γₙ varies with respect to n (n=1, . . . , N).

6. The method of claim 3, wherein γ₁< . . . <γ_{N}.

7. The method of claim 3, wherein γₙ is in a range of 0.95≤γₙ≤1 for n=1, . . . , N.

8. The method of claim 3, wherein γₙ<1 for each hidden layer n of the N hidden layers.

9. The method of claim 3, wherein γₘ=1 for at least one hidden layer m of the N hidden layers.

10. The method of claim 2, wherein ξₙ is the scalar resulting from the PDF being sampled only once.

11. The method of claim 2, wherein ξₙ is the matrix resulting from the PDF being sampled for each element of Aₙ.

12. The method of claim 2, wherein the PDF is a normal probability distribution, a half normal probability distribution, a Laplace probability distribution, or a half Laplace probability distribution.

13. A computer program product, comprising one or more computer readable storage media storing computer readable program instructions, said program instructions executable by one or more processors of a computer system to cause the computer system to perform operations, said operations comprising:
receiving, by an input layer of a trained neural network hidden layer model, a query that includes a sequence of tokens, each token being a unit of text, wherein the trained neural network hidden layer model includes N hidden layers and an output layer, and wherein N≥1;
converting, by the input layer, the sequence of tokens to embeddings;
passing the embeddings from the input layer to a first hidden layer H₁;
generating, by each hidden layer, an activation matrix A;
performing, by a Noisy Forward (NF) module between successive hidden layers: (i) clipping the matrix A to generate a clipped matrix A_{c}; (ii) generating noise ξ derived from a number randomly sampled from a probability density function (PDF) consisting of a unimodal symmetric distribution or a half unimodal symmetric distribution; (iii) computing a modified activation matrix A′ via A′=A_{c}+ξ; and (iv) passing A′ to a next hidden layer if the next hidden layer exists;
passing A′ from a last hidden layer to the output layer; and
generating and outputting, by the output layer, an answer to the query.

14. The computer program product of claim 13, wherein the hidden layers are denoted as H₁, . . . , H_{N}, and wherein said generating by each hidden layer the activation matrix A, said performing by the Noisy Forward module, and said passing A′ comprise:
$$for n = 1 , … , N :$$
(i) generating, by hidden layer Hₙ, an activation matrix Aₙ,
(ii) generating, by the Noisy Forward (NF) module NFₙ using Aₙ, a clipped matrix A_{C,n} and noise ξₙ equal to the number randomly sampled from the PDF consisting of the unimodal symmetric distribution or the half unimodal symmetric distribution or equal to an absolute value of the number randomly sampled from the PDF consisting of the unimodal symmetric distribution, wherein ξₙ is either a scalar resulting from ξₙ being sampled only once from the PDF or a matrix resulting from ξₙ being sampled from the PDF once for each element of Aₙ, and wherein the NFₙ module is disposed between hidden layer Hₙ and a next hidden layer Hₙₑₓₜ consisting of either Hₙ+1 if n<N or the output layer if n=N,
(iii) computing, by the NFₙ module, a modified activation matrix Aₙ′ via Aₙ′=A_{C,n}+ξₙ;
(iv) passing, by the NFₙ module, Aₙ′ to Hₙₑₓₜ.

15. The computer program product of claim 14, wherein said generating A_{C,n} comprises computing A_{C,n} via A_{C,n}=γₙAₙ, wherein γₙ is a parameter that has a value in a range of 0<γₙ≤1 subject to γₙ<1 being satisfied for at least one hidden layer n of the N hidden layers, and wherein the PDF includes a dependence on (1−γₙ) that controls a spread of the PDF.

16. A method, said method comprising:
receiving, by an input layer of a neural network hidden layer model, input of Q queries and Q respectively associated answers to the Q queries denoted as query 1, . . . , query Q wherein Q>1, each query including a sequence of tokens, each token being a unit of text, said neural network hidden layer model comprising the input layer, N hidden layers denoted as H₁, . . . , H_{N}, and an output layer, wherein N≥1;
converting, by the input layer, each token to an embedding for each query, wherein the embeddings are collectively denoted as E_{q} for query q (q=1, . . . , Q);
receiving, by hidden layer H₁ from the input layer, training data comprising E_{q} and R_{q}, wherein R_{q} is the answer to query q (q=1, . . . , Q);
training the neural network hidden layer model using the training data, by minimizing a loss function using backpropagation, said training comprising for each q (q=1, . . . , Q):
generating, by each hidden layer, an activation matrix A;
performing, by a Noisy Forward (NF) module between successive hidden layers: (i) clipping the matrix A to generate a clipped matrix A_{c}; (ii) generating noise ξ derived from a number randomly sampled from a probability density function (PDF) consisting of a unimodal symmetric distribution or a half unimodal symmetric distribution; (iii) computing a modified activation matrix A′ via A′=A_{c}+ξ; and (iv) passing A′ to a next hidden layer if the next hidden layer exists;
passing A′ from a last hidden layer to the output layer;
generating, by the output layer, an answer to the query q; and
minimizing the loss function, using backpropagation, with respect to a comparison between the generated answer to the query q in the output layer and the inputted answer Rq to query q.

17. The method of claim 16, wherein said generating by each hidden layer the activation matrix A, said performing by the Noisy Forward module, and said passing A′ comprise:
$$for n = 1 , … , N :$$
(i) generating, by hidden layer Hₙ, an activation matrix Aₙ,
(ii) generating, by a Noisy Forward (NF) module NFₙ using Aₙ, a clipped matrix A_{C,n} and noise ξₙ equal to the number randomly sampled from the PDF consisting of the unimodal symmetric distribution or the half unimodal symmetric distribution or equal to an absolute value of the number randomly sampled from the PDF consisting of the unimodal symmetric distribution, wherein ξₙ is either a scalar resulting from ξₙ being sampled only once from the PDF or a matrix resulting from ξₙ being sampled from the PDF once for each element of Aₙ, and wherein the NFₙ module is disposed between hidden layer Hₙ and a next hidden layer Hₙₑₓₜ consisting of either Hₙ₊₁ if n<N or the output layer if n=N,
(iii) computing, by the NFₙ module, a modified activation matrix Aₙ′ via Aₙ′=A_{C,n}+ξₙ;
(iv) passing, by the NFₙ module, Aₙ′ to Hₙₑₓₜ.

18. The method of claim 17, wherein said generating A_{C,n} comprises computing A_{C,n} via A_{C,n}=γₙAₙ, wherein γₙ is a parameter that has a value in a range of 0<γₙ≤1 subject to γₙ<1 being satisfied for at least one hidden layer n of the N hidden layers, and wherein the PDF includes a dependence on (1−γₙ) that controls a spread of the PDF.

19. The method of claim 18, wherein N≥2, and wherein γₙ is a constant whose value γ is independent of n (n=1, . . . , N).

20. The method of claim 18, wherein N≥2, and wherein γₙ varies with respect to n (n=1, . . . , N).
